(19) United States
(12) Patent Application Publication
(10) Pub. No.: US 2024/0296758 A1
(43) Pub. Date: Sep. 5, 2024

(54) Self-Unfurling Cardboard Cutout Figure Stand

(71) Applicant: Diesel Interactive, LLC, Carrollton, TX (US)

(72) Inventors: Brent Ashton, Lakewood Village, TX (US); Adam Weeks, Dallas, TX (US); Jacob Pierson, Lewisville, TX (US)

(21) Appl. No.: 18/117,386

(22) Filed: Mar. 3, 2023

(51) Int. Cl. G09F 1/06

(52) U.S. Cl. CPC G09F 1/065

(57) ABSTRACT

A self-unfurling stand includes a center panel with two side panels that are pivotally coupled to the center panel. The center panels have transverse scored fold lines enabling them to be folded in a flat compact storage configuration. The side panels are joined by at least one transversely disposed elastic band that are configured to pivotally pull the side panels toward one another. At least one longitudinally disposed elastic band joins the at least one transverse flap to the center panel to pivotally pull the at least one transverse flap open. The elastic tension of the transversely disposed elastic bands and the longitudinally disposed elastic bands automatically unfurl and unfold the center panel and side panels and automatically orient the at least one transverse flap to brace against the side panels so that the stand automatically transforms from the flat storage configuration to a 3-dimensional display configuration.

### FIELD

The present disclosure relates to a self-unfurling stand for displaying a cardboard cutout figure and method of manufacturing.

### BACKGROUND

Life-size cardboard cutout figures (also known as standees) that commonly feature the likeness of celebrities, fictional characters, and spokespersons are commonly used to promote movies, products, services, and events. Some are used for point-of-sale marketing and advertising, while some custom-order cardboard cutout figures are created for special events such as birthdays, graduations, and other personalized celebrations. The typical cardboard cutout figures have a cardboard backflap that can be unfolded to form a stand to keep the cardboard figure erect.

### BRIEF DESCRIPTION OF THE DRAWINGS

A better understanding of the claimed subject matter can be obtained when the following detailed description of the disclosed embodiments is considered in conjunction with the following figures.

FIG. 1A is a front perspective view of an embodiment of a foldable self-unfurling stand for displaying a cardboard cutout figure according to the teachings of the present disclosure.

FIG. 1B is a simplified end view illustration of an embodiment of a foldable self-unfurling stand for displaying a cardboard cutout figure according to the teachings of the present disclosure.

FIG. 2 is a front perspective view of an embodiment of a foldable self-unfurling stand for presenting a cardboard cutout figure in its display configuration according to the teachings of the present disclosure.

FIG. 3 is a top plan view of a cardboard material showing cuts and fold score lines for an embodiment of a foldable self-unfurling stand for presenting a cardboard cutout figure according to the teachings of the present disclosure.

FIG. 4A is a top plan view of an embodiment of a foldable self-unfurling stand for presenting a cardboard cutout figure in a partially folded configuration according to the teachings of the present disclosure.

FIG. 4B is a front perspective view of an embodiment of a foldable self-unfurling stand for presenting a cardboard cutout figure in a partially folded configuration according to the teachings of the present disclosure.

FIG. 5 is a partial rear plan detailed view of an embodiment of a foldable self-unfurling stand for presenting a cardboard cutout figure according to the teachings of the present disclosure.

### DETAILED DESCRIPTION

The traditional cardboard cutout figure (commonly called a standee) typically has an attached backflap that can be positioned to lie in an axis perpendicular (90°) to the plane of the cardboard figure to prop and support the cutout figure vertically and keep it erect. The backflap may incorporate one or more additional cutout flap members that may be folded to maintain the perpendicular configuration of the backflap. To take the cardboard cutout standee out of the packaging and install it in an upright position is a two-handed operation, requiring the user to manually fold the backflap and each cutout flap member and position them in the correct configuration.

The novel cardboard figure cutout stand 100 described herein is designed to automatically unfold from a flat and compact storage configuration into a 3-dimensional full-length display configuration ready for use without requiring manipulation by the user. The cutout figure stand 100 is a compact manageable size for storage and shipping, but it can unfurl automatically for deployment.

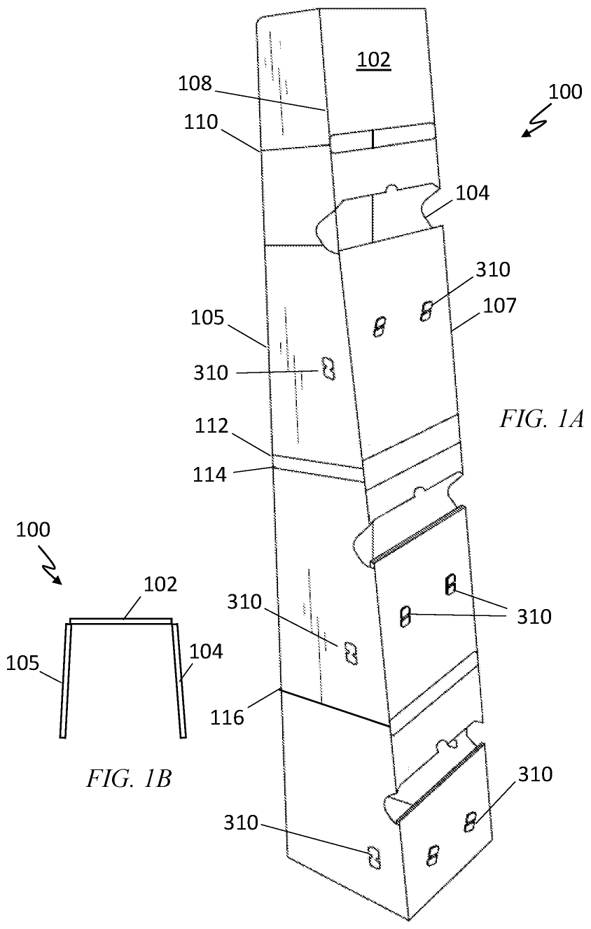

FIG. 1A shows a front perspective view of an embodiment of the cardboard figure cutout stand 100 according to the teachings of the present disclosure. Referring to FIG. 1A, the cardboard figure cutout stand 100 has a generally planar rectangular center panel 102 that forms the main support member of the stand 100 and two parallel side panels 104 and 105 formed to either side of the center panel 102. The orientation of the two side panels 104 and 105 relative to the center panel 102 is adjustable. The side panels 104 and 105 lie flat in the same plane as the center panel 102 for storage or oriented to become substantially perpendicular to the center panel 102. In the display or deployed configuration, as shown in FIGS. 1A and 1B, the side panels 104 and 105 and the center panel 102 have a generally U-shaped cross-section when viewed from one end of the stand 100.

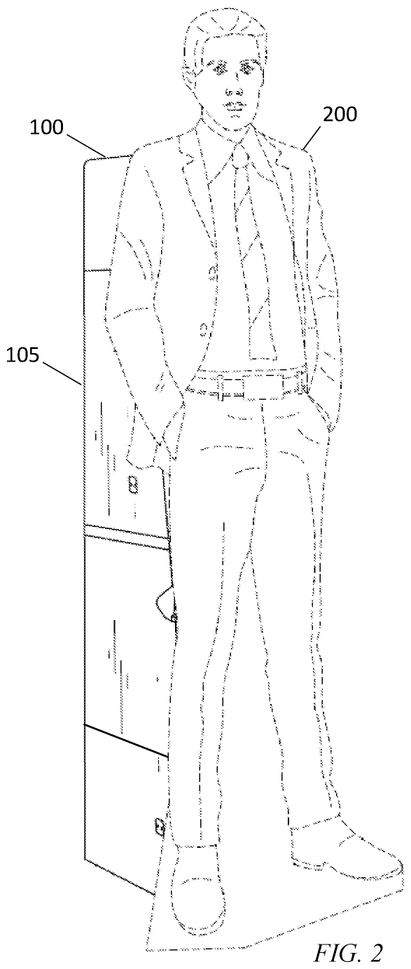

FIG. 2 is a front perspective illustration of the cardboard figure cutout stand 100 attached to a life-size cardboard cutout FIG. 200 (also commonly called a standee) in the deployed or display configuration designed to keep the cutout FIG. 200 erect and upright in a stable manner. In a preferred embodiment, the stand 100 is slightly inclined to present the cutout FIG. 200 at an optimal angle.

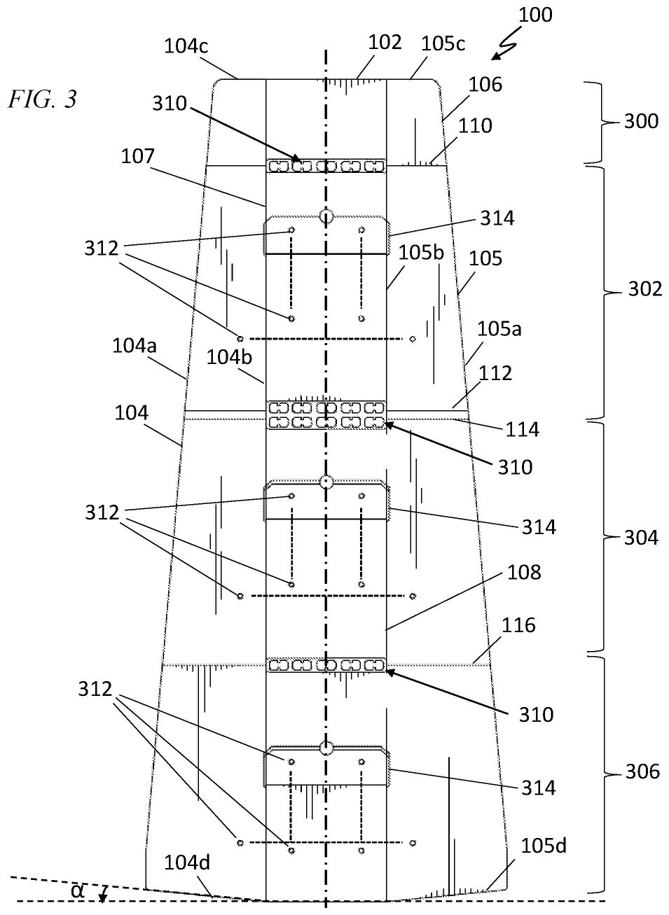

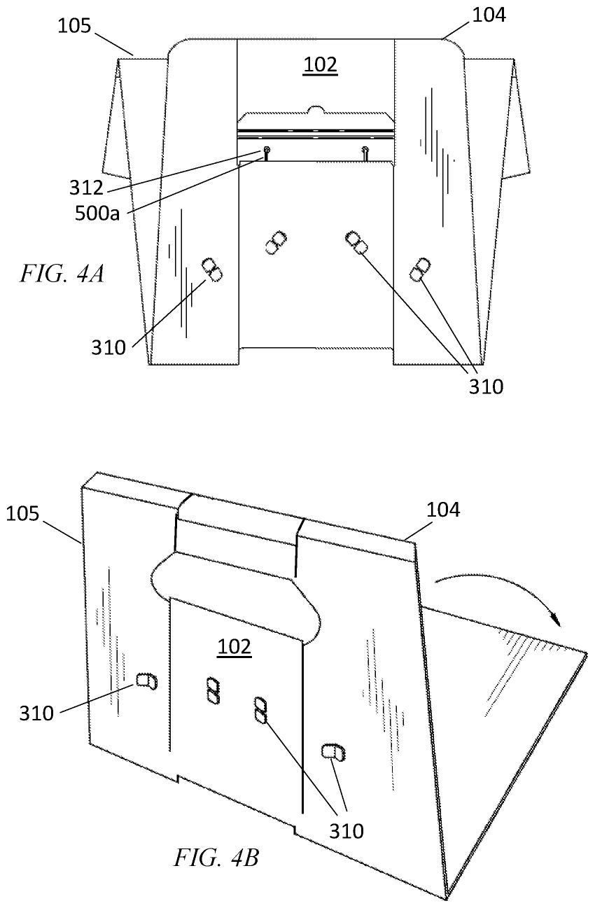

The construction and fabrication of the cardboard figure cutout stand 100 is better shown in FIG. 3, which provides a top plan view of a piece of cardboard material 106 showing the contours of the carboard cutout stand 100, and additional cuts and score lines formed therein for manufacturing purposes. Referring to FIG. 3, the center panel 102 and side panels 104 and 105 of the cutout stand 100 may be fabricated from a single piece of cardboard material with longitudinal score lines 107 and 108 defining the fold lines to enable the side panels 104 and 105 to be easily oriented with respect to the center panel 102. Further, the stand 100 has a series of transverse score lines 110-116 disposed along its length that divides the stand 100 into a plurality of segments 300-306 that enable the stand 100 to be folded into a folded storage configuration that has more compact dimensions.

In an alternative embodiment, the center panel 102 and side panels 104 and 105 of the stand 100 may be fabricated from separate pieces of cardboard material and then attached to form a single unit. Although the cutout stand 100 is described herein to be constructed of cardboard, other materials such as plastic and wood may be used.

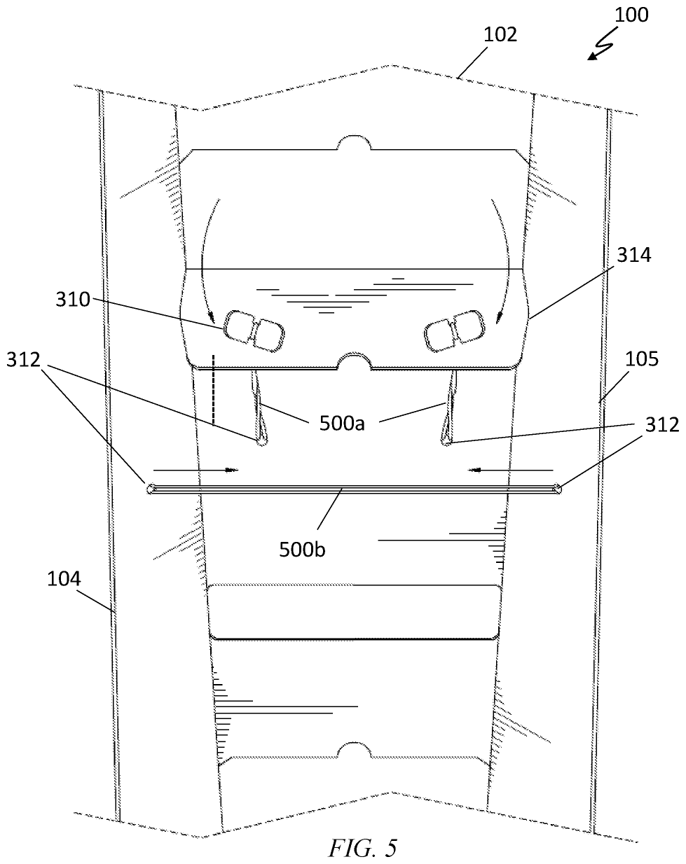

Continue to refer to FIG. 3, the stand 100 further includes a number of cuts in the cardboard material that form butterfly-shaped tie ends 310 used to secure the ends of elastic bands (rubber bands) 500a and 500b (see FIG. 5) to the stand 100 through pairs of small holes or openings 312 strategically distributed along the length of the stand 100. Further, a number of transverse flaps 314 arranged longitudinally along the center panel 102 are cut and formed in the cardboard material. The base of the transverse flaps 314 are scored to facilitate opening the flaps to reveal a window opening formed in the center panel. The width of the transverse flaps 314 are equal to or slightly longer than the width of the center panel 102.

Continuing to refer to both FIGS. 3 and 5, the pairs of small openings 312 are sized to permit the ends of elastic bands 500a and 500b to pass through but block the passage of the butterfly tie ends 310 fastened to the ends of the elastic bands 500a and 500b. During assembly, the user or assembly worker punches out the cut butterfly tie ends 310 from the cardboard material. The elastic bands 500a and 500b are passed through pairs of openings 312 and each end of the elastic bands 500a and 500b is looped around a butterfly tie end 310 and pulled taut around the center of the butterfly tie ends 310. In this way, the elastic bands are securely fastened to the stand 100. The dashed lines in FIG. 3 indicate the locations of the pairs of openings joined together by elastic bands, where elastic bands 500a are oriented longitudinally and elastic bands 500b are oriented transversely (see also FIG. 5). The transverse elastic bands 500b are located along the length of the stand 100 and designed to use their elastic tension to pull the side panels toward each other so that their orientation is deviated away from the same plane as the center panel 102. The longitudinal elastic bands 500a are designed to use their elastic tension to pull the transverse flaps 314 so that their orientation is deviated away from the same plane as the center panel 102. The transverse flaps 314 are designed to function as brace members against the side panels 104 and 105 to maintain their orientation in the display configuration.

The cardboard cutout figure stand 100 is quick and easy to deploy for use. In operation, the elastic tension of the elastic bands 500a and 500b enables the cardboard stand 100 to automatically unfurl and unfold from the compact storage configuration. The horizontally (or transversely) arranged elastic bands 500b function to automatically pull the side panels 104 and 105 toward one another. At the same time, the vertically (or longitudinally) arranged elastic bands 500a function to automatically pull down the transverse flaps 314 so that they brace against the side panels 104 and 105. The side panels 104 and 105 come to rest against the transverse flaps 314 at an orientation that is nearly perpendicular to the plane of the center panel 102. Because the transverse flaps 314 are preferably slightly wider than the width of the center panel 102, the side panels 104 and 105 extend outwardly at a slight angle from 90°. The slight angular stance produces a wider and more stable base for the stand 100. The automatic unfurling action of the side panels 104 and 105 also simultaneously prompts the segments 300-306 to automatically unfold to its full length. The standee 200 may be affixed to the stand 100 using temporary adhesive tabs, hook and loop devices, or other suitable fasteners.

In a preferred embodiment, the side panels 104 and 105 are scalene trapezoidal (with sides 104a-d and 105a-d) in shape, where one of the longer sides (104b and 105b) is attached to the long sides of the generally rectangular center panel 102. As shown in FIG. 3, the bottom sides 104d and 105d of each side panel 104 and 105 are angled at an acute angle α so that when in the stand 100 is in the display configuration, the stand 100 will lean slightly off of the vertical to present the cutout figure at an optimal angle.

It should be noted that the stand 100 may have two or more number of segments. It is also understood that the side panels 104 and 105 may form the base of the stand and may not extend the entire length of the stand. The stand 100 may also be sized so that it does not extend the entire length of the standee it is designed to support.

The features of the present disclosure which are believed to be novel are set forth below with particularity in the appended claims. However, modification, variations, and changes to the exemplary embodiments described above will be apparent to those skilled in the art, and the disclosure described herein thus encompasses such modification, variations, and changes and are not limited to the specific embodiments described herein.

What is claimed is:

1. A self-unfurling stand comprising:
an elongated and generally planar center panel having first and second elongated sides, the center panel having at least one transverse flap;
first and second elongated side panels pivotally coupled in parallel to the first and second elongated sides of the center panel, the center panel and side panels being co-planar when in a flat storage configuration;
at least one transversely disposed elastic band joining the first and second side panels, the at least one transversely disposed elastic band having an elastic tension configured to pivotally pull the first and second side panels toward one another;
at least one longitudinally disposed elastic band joining the at least one transverse flap to the center panel, the at least one longitudinally disposed elastic band having an elastic tension configured to pivotally pull the at least one transverse flap open;
the center panel and first and second side panels further having at least one transverse score line enabling the center panel and first and second side panels to be folded in a flat compact storage configuration; and
the elastic tension of the at least one transversely disposed elastic band and the at least one longitudinally disposed elastic band automatically unfurl and unfold the center panel and first and second side panels and automatically orient the at least one transverse flap to brace against the first and second side panels so that the stand automatically transforms from the flat storage configuration to a 3-dimenstional display configuration.

2. The self-unfurling stand of claim 1, wherein the center panel and first and second side panels are fabricated from a single piece of cardboard material, where the first and second side panels are formed by parallel longitudinal score lines defined in the single piece of cardboard material.

3. The self-unfurling stand of claim 1, wherein the center panel and the at least one transverse flap are fabricated from a single piece of cardboard material, where the at least one transverse flap is formed by cutting the single piece of cardboard material.

4. The self-unfurling stand of claim 1, wherein the at least one transversely disposed elastic band is secured to the first and second side panels by at least one pair of tie ends, where the at least one pair of tie ends are formed by cutting a single piece of cardboard material used to fabricate the center panel and first and second side panels.

5. The self-unfurling stand of claim 1, wherein the at least one longitudinally disposed elastic band is secured to the center panel and the at least one transverse flap by at least one pair of tie ends, where the at least one pair of tie ends are formed by cutting a single piece of cardboard material used to fabricate the center panel and first and second side panels.

6. The self-unfurling stand of claim 1, wherein the center panel and first and second side panels have a plurality of transverse score lines forming a plurality of segments that can be folded in a flat compact storage configuration.

7. The self-unfurling stand of claim 1, wherein the and first and second side panels are joined by at least one transversely disposed elastic band having its ends passed through small openings defined in the side panels and looped around butterfly-shaped tie ends, and the at least one transverse flap is joined to the center panel by at least one longitudinally disposed elastic band having its ends passed through small openings defined in the transverse flap and center panel and looped around butterfly-shaped tie ends, where the butterfly-shaped tie ends have dimensions greater than the small openings.

8. The self-unfurling stand of claim 1, wherein a width of the at least one transverse flap is equal to or greater than a width of the center panel, and a bottom side of the first and second side panels is angled.

9. A self-unfurling stand for a cardboard cutout figure, comprising:
a generally planar cardboard material;
a plurality of first cuts in the cardboard material defining an elongated center panel having first and second elongated side panels disposed on either side of the center panel, the side panels being defined by a pair of parallel longitudinal score lines formed in the cardboard material;
a plurality of second plurality of cuts in the cardboard material defining and forming a plurality of transverse flaps in the center panel;
a first plurality of holes formed in the first and second side panels, the first plurality of holes being configured for receiving ends of a plurality of transversely disposed elastic band joining the first and second side panels, the plurality of transversely disposed elastic bands having an elastic tension configured to pivotally pull the first and second side panels toward one another;
a second plurality of holes formed in the center panel and the plurality of transverse flaps, the second plurality of holes being configured for receiving ends of a plurality of longitudinally disposed elastic bands joining the plurality of transverse flaps to the center panel, the plurality of longitudinally disposed elastic bands having an elastic tension configured to pivotally open the plurality of transverse flaps; and
a plurality of transverse score lines dividing the center panel and first and second side panels into a plurality of segments that can be folded in a flat compact storage configuration.

10. The self-unfurling stand of claim 9, wherein the at least one transversely disposed elastic band is secured to the first and second side panels by at least one pair of tie ends, where the at least one pair of tie ends are formed by cutting a single piece of cardboard material used to fabricate the center panel and first and second side panels.

11. The self-unfurling stand of claim 9, wherein the at least one longitudinally disposed elastic band is secured to the center panel and the at least one transverse flap by at least one pair of tie ends, where the at least one pair of tie ends are formed by cutting a single piece of cardboard material used to fabricate the center panel and first and second side panels.

12. The self-unfurling stand of claim 9, wherein the first and second side panels are joined by the plurality of transversely disposed elastic bands having their ends passed through the first plurality of holes defined in the side panels and looped around butterfly-shaped tie ends, and the plurality of transverse flaps are joined to the center panel by the plurality of longitudinally disposed elastic band having their ends passed through the second plurality of holes defined in the transverse flaps and center panel and looped around butterfly-shaped tie ends, where the butterfly-shaped tie ends have dimensions greater than the first and second plurality of holes.

13. The self-unfurling stand of claim 9, further comprising a plurality of tie ends cut and defined in the cardboard material.

14. The self-unfurling stand of claim 9, further comprising a plurality of butterfly-shaped tie ends cut and defined in the center panel.

15. The self-unfurling stand of claim 9, wherein a width of the plurality of transverse flaps is equal to or greater than a width of the center panel.

16. A self-unfurling stand for a cardboard cutout figure, comprising:
an elongated center panel having first and second elongated side panels disposed on either side of the center panel fabricated from a piece of generally planar cardboard material, the center and side panels being defined by a pair of parallel longitudinal score lines formed in the cardboard material;
a plurality of transverse flaps formed in the center panel;
a first plurality of holes disposed in the first and second side panels, the first plurality of holes being configured for receiving ends of a plurality of transversely disposed elastic band joining the first and second side panels, the plurality of transversely disposed elastic band having an elastic tension configured to pivotally pull the first and second side panels toward one another;
a second plurality of holes disposed in the center panel and the plurality of transverse flaps, the second plurality of holes being configured for receiving ends of a plurality of longitudinally disposed elastic band joining the plurality of transverse flaps to the center panel, the plurality of longitudinally disposed elastic bands having an elastic tension configured to pivotally open the plurality of transverse flaps;
a plurality of transverse score lines dividing the center panel and first and second side panels into a plurality of segments that can be folded in a flat compact storage configuration; and
the elastic tension of the transversely disposed elastic bands and the longitudinally disposed elastic bands is configured to automatically unfurl and unfold the plurality of segments of the center panel and first and second side panels, automatically pull the first and second side panels toward one another, and automatically orient the plurality of transverse flaps to brace against the first and second side panels so that the stand automatically transforms from the flat compact storage configuration to a 3-dimensional display configuration.

17. The self-unfurling stand of claim 16, wherein the plurality of transversely disposed elastic bands are secured to the first and second side panels by a plurality pairs of tie ends, where the plurality pairs of tie ends are formed by cutting the cardboard material used to fabricate the center panel and first and second side panels.

18. The self-unfurling stand of claim 16, wherein the plurality of longitudinally disposed elastic bands are secured to the center panel and the plurality of transverse flaps by a plurality pairs of tie ends, where the plurality pairs of tie ends are formed by cutting the cardboard material used to fabricate the center panel and first and second side panels.

19. The self-unfurling stand of claim 16, wherein the first and second side panels are joined by the plurality of transversely disposed elastic bands having their ends passed through the first plurality of holes defined in the side panels and looped around butterfly-shaped tie ends, and the plurality of transverse flaps are joined to the center panel by the plurality of longitudinally disposed elastic band having their ends passed through the second plurality of holes defined in the transverse flaps and center panel and looped around butterfly-shaped tie ends, where the butterfly-shaped tie ends have dimensions greater than the first and second plurality of holes.

20. The self-unfurling stand of claim 16, wherein a width of the plurality of transverse flaps is equal to or greater than a width of the center panel.
